(19) United States
(12) Patent Application Publication
(10) Pub. No.: US 2026/0365041 A1
(43) Pub. Date: Nov. 19, 2026

(54) Vehicle High Voltage Electronics Box with An Open-End Winding Machine

(71) Applicant: Schaeffler Technologies AG & Co. KG, Herzogenaurach (DE)

(72) Inventors: Yicheng Wang, Windsor (CA); Wesam Taha, Windsor (CA); Aniket Anand, Windsor (CA)

(73) Assignee: Schaeffler Technologies AG & Co. KG, Herzogenaurach (DE)

(21) Appl. No.: 19/490,651

(22) PCT Filed: May 9, 2024
(86) PCT No.: PCT/US2024/028519

§ 371 Date: Dec. 5, 2025

Related U.S. Application Data
(60) Provisional application No. 63/500,963, filed on May 9, 2023.
(60) Provisional application No. 63/507,711, filed on Jun. 12, 2023.
(60) Provisional application No. 63/610,237, filed on Dec. 14, 2023.
(60) Provisional application No. 63/565,466, filed on Mar. 14, 2024.

(51) Int. Cl. B60L 50/60; B60L 53/24; H02M 1/42; H02M 3/00; H02M 3/335; H02M 7/797

(52) U.S. Cl. CPC B60L 50/60; B60L 53/24; H02M 1/4233; H02M 3/01; H02M 3/33573; H02M 3/33584; H02M 3/33592; H02M 7/797; B60L 2210/14; B60L 2210/30; B60L 2210/42; B60L 2220/54

(57) ABSTRACT

A system operating in at least two modes of operation based on an input is disclosed. The system is supported by an electric vehicle (EV). The system includes: an input receiving input data from one or more sensors; an Open-Ended Winding Machine (OEWM); and an inverter connected to the OEWM. The system also includes a DC-link capacitor connected to the inverter and a DC-DC converter connected to the DC-link capacitor and a high voltage (HV) battery.

### TECHNICAL FIELD

The disclosure relates to a vehicle electronics box with an open-end winding that functionally and electrically integrates several electrical power electronics.

### BACKGROUND

An electric car, an electric vehicle (EV), or a battery electric vehicle are all used to describe automobiles powered by one or more electric motors using energy stored in one or more rechargeable energy storage units such as batteries or other electricity storage devices such as supercapacitors. Electric vehicles (EV) have one or more complex networks of power electronics where each includes converters, inverters, and control systems. Each complex network of power electronics converts and manages electrical energy to drive the vehicle, charge the vehicle battery, and ensure overall system efficiency. To fulfill such functionalities, various power electronics subsystems, packaged individually, are found under the EV vehicle hood.

Current market projections anticipate a highly integrated power electronics system in the next generation of battery electric vehicles (BEV). Overall reduction in size, cost, and weight of power electronics converters, onboard chargers (OBC), traction inverters, and auxiliary power modules (APM) are some of the key factors to achieve the highly integrated system. The transition from low-switching frequency converters to high-switching frequency converters has drastically reduced the size and cost of the magnetics in the system. Moreover, the hybrid solution with combinations of different wide band gap devices like SiC and GaN at different stages of power conversion offers further cost savings and efficiency improvement.

Some of the known solutions to the above-mentioned deficiencies are described in U.S. Patent Application Publication No. 20110221363A1 which relates to a combined electric device for powering and charging and proposes a device for the open-end winding machine. The machine includes three H bridges and operates in two operating modes: powering mode in which two inverters are used to feed the alternating current to open end winding machine and charging mode when motor windings are used as an inductor to feed three-phase power from the grid to the battery.

Another solution is discussed in U.S. Patent Application Publication No. 20190126763A1 which relates to a combined electric device for powering and charging. This application claims a charging system utilizing a six-phase machine with two sets of galvanically isolated windings. A vehicle includes two inverters and three-phase inductors. In this case, isolation is provided between battery and charge port in the proposed charging system using six-phase machine.

Another solution is discussed in U.S. Patent Application Publication No. 20170305283A1 which relates to an integrated charger for vehicles. This application provides a traction system with an additional inductor in series with motor winding to realize a DC-DC converter. Two additional inductors with two-phase windings are realized as a DC-DC converter. Buck-boost DC-DC converter is formed using additional inductors and motor winding for charging.

Yet another solution is discussed in U.S. Patent Application Publication No. 20130307333A1 which relates to an inverter-charger combined device for electric vehicles. This application provides a system with an additional single-phase rectifier and buck converter. An inverter charger combined device utilizes the three-phase motor windings. The device claims the functionality of high voltage charger, low voltage charger, and inverter operation.

The known described systems discuss a traditional battery electric vehicle system which includes independent power electronics conversion systems that includes the traction inverter for driving the electric machine, an OBC for charging the high voltage (HV) battery from the AC grid, a DC boost charger for charging the HV battery from the legacy 400 V DC charger, and an APM for feeding different auxiliary loads. Therefore, there is a need for a system that functionally and electrically integrates several independent power conversion systems into one box.

### SUMMARY

One aspect of the disclosure provides a system operating in at least two modes of operation based on an input. The system is supported by an electric vehicle. The system includes an input for receiving input data from one or more sensors supported by the vehicle, and an Open-Ended Winding Machine (OEWM). The system also includes an inverter connected to the OEWM; a DC-link capacitor connected to the inverter; and a DC-DC converter connected to the DC-link capacitor and a high voltage (HV) battery.

Implementations of the disclosure may include one or more of the following optional features. In some implementations, the DC-DC converter includes a HV DC-DC converter providing bidirectional power to and from the HV battery. In some examples, the DC-DC converter includes an LV DC-DC converter configured to supply power to an LV load. In some examples, the DC-DC converter includes a first DC-DC converter and a second DC-DC converter.

In some implementations, when the input data is indicative of the EV being in a driving status, the HV battery supplies power to the OEWM during a traction mode of operation. When the input data is indicative of the EV being connected to an alternating voltage source, the OEWM and the inverter behave as a three phase Vienna PFC to convert alternating power from the alternating voltage source to direct power during an AC charging mode of operation.

In some examples, when the input data is indicative of the EV being connected to an alternating voltage source, the OEWM and the inverter behave as a three phase ANPC PFC to convert alternating power from the alternating voltage source to direct power during an AC charging mode of operation.

When the input data is indicative of the EV being connected to a direct voltage source, the OEWM and the inverter behave as a three-phased interleaved boost converter circuit to boost direct power from the direct voltage source during a DC boost charging mode of operation.

In some implementations, the inverter includes one of two-level voltage source inverter, a three-level voltage source inverter, or a Gallium Nitrade 3L active neutral-point-clamped (ANCP) traction inverter. The DC-link capacitor may be a split DC-link capacitor. The one or more sensors may include voltage sensor, current sensors, and vehicle motion sensor.

Another aspect of the disclosure provides a method of operating a system based on an input to the system. The system being supported by an electric vehicle. The method includes receiving input data from the input. When the input data is indicative of the EV being in a driving status, the method includes executing a first mode of operation causing a high voltage battery supported by the EV to supply power to an OEWM of the EV; and when the input data is indicative of the EV being connected to an alternating voltage source, the method includes executing a second mode of operation causing the OEWM and an inverter supported by the EV to behave as a PFC circuit to convert alternating power from the alternating voltage source to direct power.

Implementations of this aspect of the disclosure may include one or more of the following optional features. In some implementations, when the input data is indicative of the EV being connected to a direct voltage source, the method further includes executing a third mode of operation causing the OEWM and the inverter to behave as a three-phase interleaved boost converter circuit to boost direct power from the direct voltage source. The first, second, and third modes of operation are mutually exclusive.

In some examples, the first mode of operation causes the high voltage battery to supply power to one or more low voltage loads supported by the EV. The input data includes at least one of a voltage sensor data, a current sensor data, and vehicle motion sensor data. The PFC circuit may include a three-phase Vienna PFC or a three-phase ANPC PFC.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary system supported by an electric vehicle.

FIG. 2 is a schematic view of the exemplary system supported by the electric vehicle shown in FIG. 1.

FIG. 3A is a schematic view of an exemplary circuit of the system of FIG. 1.

FIG. 3B is a schematic view of the circuit shown in FIG. 3A during its modes of operation.

FIG. 4A is a schematic view of an exemplary circuit of the system of FIG. 1.

FIG. 4B is a schematic view of the circuit shown in FIG. 4A during its modes of operation.

FIG. 5A is a schematic view of an exemplary circuit of the system of FIG. 1.

FIG. 5B is a schematic view of the circuit shown in FIG. 5A during its modes of operation.

FIG. 6A is a schematic view of an exemplary circuit of the system of FIG. 1.

FIG. 6B is a schematic view of the circuit shown in FIG. 6A during its modes of operation.

FIG. 7A is a schematic view of an exemplary circuit of the system of FIG. 1.

FIG. 7B is a schematic view of the circuit shown in FIG. 7A during its modes of operation.

FIG. 8A is a schematic view of an exemplary circuit of the system of FIG. 1.

FIG. 8B is a schematic view of the circuit shown in FIG. 8A during its modes of operation.

FIG. 9A is a schematic view of an exemplary circuit of the system of FIG. 1.

FIGS. 9B and 9C are schematic views of the circuit shown in FIG. 9A during its modes of operation.

FIG. 10A is a schematic view of an exemplary circuit of the system of FIG. 1.

FIG. 10B is a schematic view of the circuit shown in FIG. 10A during its modes of operation.

FIG. 11A is a schematic view of an exemplary circuit of the system of FIG. 1.

FIG. 11B is a schematic view of the circuit shown in FIG. 11A during its modes of operation.

FIG. 12 is a schematic view of an exemplary arrangement of operations for a method of operating the system of FIGS. 1-11B.

Like reference symbols in the various drawings indicate like elements.

### DETAILED DESCRIPTION

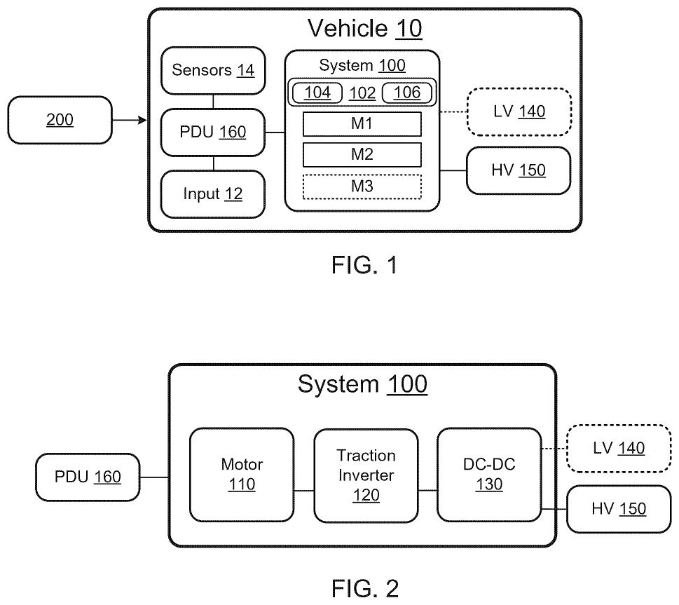

The disclosure provides a highly integrated system 100 supported by a vehicle 10 shown in FIGS. 1 and 2. In some examples, the system 100 is a high voltage electronics box that functionally and electrically integrates several sub-systems of the vehicle 10. The system 100 includes independent power conversion sub-systems each supporting several electronics of a battery electric vehicle (BEV) 10. The system 100 supports an 800 Volt vehicle architecture, a motor drive, three phase/single phase AC charging, DC boost charging, and LV (low voltage) DC-DC. In other words, the system 100 includes several power electronics conversion sub-systems that are part of the system 100, i.e., the HV electronics box, resulting in reduced size, cost, and weight of power electronics converters in the BEV 10 by having a single integrated system 100.

The system 100 integrates the following high voltage power electronics: traction inverter, on-board charger (OBC), DC boost charger, and high voltage to low voltage (LV) DC-DC converter. The traction inverter is essential to the system 100 since it converts a direct current (DC) supply from the vehicle's batteries into an alternating current (AC) output. The OBC, e.g., including AC charging circuits, converts AC power from external sources, such as residential outlets, to DC power that is used to charge the vehicle's battery pack. The DC Boost Charger converter steps up the voltage while stepping down the current from its input (supply) to its output (load). For example, the DC boost charger can boost the voltage from 400V to 800V. In addition, the LV DC-DC converter provides power flow from high voltage, such as 800V, to low voltage such as 12V. The benefits of the system 100 include having the three phase (3P)/single phase (1P) OBC, and traction inverter within one package; bidirectional AC and DC boost charging utilizing inverter power module and motor winding; and significant device volume and cost reduction; and following the automotive industry's high integration trend. Additionally, the system 100 utilizes motor windings of an Open-end Winding Machine (OEWM) for AC and DC boost charging and eliminates the input inductors compared to a conventional non-integrated OBC and boost charger.

The system 100 includes several levels of integration. A first level of integration includes a traction inverter and a PFC converter where all of the inverter switches are reused to realize a three/single phase PFC converter for charging. Secondly, for the DC boost charging from 400 V DC source to 800 V DC, the same inverter switches are used to achieve an interleaved DC boost converter operating in continuous conduction mode. Thirdly, the magnetic integration where both HV DC-DC and low voltage (LV) DC-DC isolation is provided by a single three-port transformer. Lastly, and in some examples, motor windings are utilized as the PFC coil and the boost inductor, thus, further reducing the magnetic requirement. As such, the system 100 provides a significant volume and cost reduction.

The system 100 includes a controller 102 having a computing device (or processor) 104 (e.g., central processing unit having one or more computing processors) in communication with non-transitory memory 106 (e.g., a hard disk, flash memory, random-access memory) capable of storing instructions executable on the computing processor(s) 104. In some examples, the controller 102 executes a method for determining a mode of operation M1, M2, M3 of the system 100 based on one or more inputs 12. In some examples, the input 12 includes sensor data from one or more sensors 14 indicative of the vehicle motion, i.e., speed, angular speed, position, etc. The sensors 14 may include an inertial measurement unit (IMU) configured to measure the vehicle's linear acceleration (using one or more accelerometers) and rotational rate (using one or more gyroscopes). Additionally, the sensors 14 may include voltage and current sensors to determine if the vehicle 10 is being charged and the type of charging input (e.g., AC or DC).

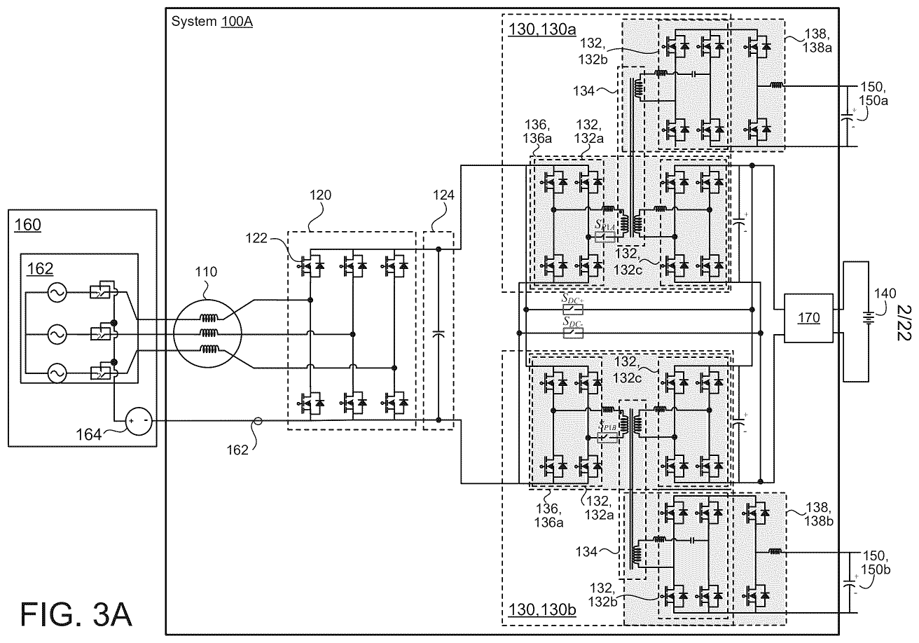

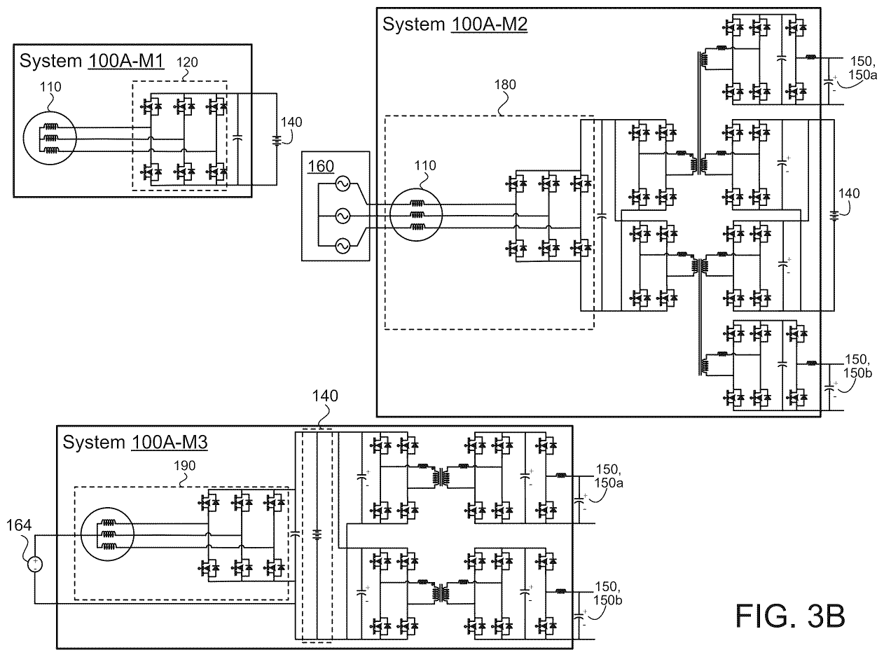

Referring to FIG. 3A, the system 100 supports an 800V BEV and includes a motor 110, a traction inverter 120, a DC-DC link capacitor 124, and a three port DC-DC converter 130. The motor 110 is an Open-Ended Winding Machine (OEWM) or Six-Phase Machine for supporting both 1P and 3P charging. The system 100 may be adjusted and reconfigured to accommodate several vehicle architectures and requirements as will be discussed in FIGS. 3A-11B.

The OEWM 110 is used to convert stored electrical energy (e.g., from the HV battery 140, i.e., 800V) to mechanical energy causing the vehicle 10 to move. The three phase OEWM 110 is a type of three phase machine having three phase windings and operating with three phase power. The coils for the stator or rotor of a three-phase OEWM are open-ended. Unlike the conventional Y connected three phase machine, the three phase coils in OEWM are not connected in a closed loop. The current going through each phase of the OEWM can be independently controlled by accessing both sides of a phase. In some examples, the OEWM 110 requires AC power to operate, as such a traction inverter 120 is used to convert the DC power from the battery source i.e., HV battery 140, into a three-phase AC power.

The traction inverter 120 is a 2-level voltage source inverter which is configured to convert a DC supply from the HV battery 140 into an AC current for the OEWM 110. In some examples, the inverter 120 is a 3-phase power module. The traction inverter 120 includes six switches 122 configured to switch the voltage and current from high-voltage battery on and off to create the AC drive for the OEWM 110. In some examples, the switches are a MOSFET or IGBT. The traction inverter 120 is electrically connected to a DC-link capacitor 124. The DC-link capacitor 124 is configured to smooth out and steady DC voltage to protect the traction inverter 120 by absorbing sudden voltage increases.

In some examples, as shown in FIG. 3A, the system 100 includes two isolated DC-DC Triple active bridge (TAB) converters, i.e., three-port DC-DC converter 130, 130a, 130b where each TAB 130, 130a, 130b includes three H-bridges 132 interlined using a three-port transformer 134, e.g., a three winding high frequency transformer (HFT). In some examples, a serial resonant converter or a combination of the TAB 130 and serial resonant converter may be used instead of the two TABs 130 shown. Each TAB 130 includes three ports. A first port is electrically connected to the DC-link capacitor 124 (Port 1), a second port is electrically connected to the HV battery 140 (Port 2), and a third port is connected to a LV load 150 (Port 3). The three ports are electrically isolated via the three-port transformer 134. Therefore, the three-port DC-DC converter 130 includes a HV DC-DC converter 136 (Port 2) connected to a high voltage (HV) battery 140 and an APM 138 (port 3) connected to a LV load 150. The first TAB 132a and the third TAB 132c together are referred to as a HV DC-DC converter 136; while the third TAB is referred to as the auxiliary power module (APM) 138.

The system 100 also includes a high voltage (HV) battery 140, such as an 800V battery and optionally one or more low voltage (LV) loads 150, 150a, 150b. The HV battery 140 is a rechargeable energy storage that supplies power to the OEWM 110 of the vehicle 10 when the HV battery 140 is charged. The HV battery 140 is charged by way of the grid connected to the vehicle during a charging state. The LV load 150 is used to power vehicle devices such as, but not limited to 12 V battery, battery disconnects, etc. In some examples, the LV load 150 is 400V for powering auxiliary loads such as the heating-ventilation-air conditioning (HVAC). In some examples, the voltage of the HV battery 140 at the third port P3 is determined by a battery state-of-charge (SOC) which represents the percentage of charge remaining in the HV battery 140 and may be determined by way of several methods. Several methods may be used, including, but not limited to the Coulomb Counting Method which is also referred to as the Ampere-Hour counting and current integration which relies on battery current readings mathematically integrated over a usage period to calculate the SOC value. In some examples, the voltage V of the HV battery 140 is measured by a voltage sensor.

The system 100 also includes a first relay S_{DC+} and a second relay S_{DC-}. A relay is an electrically operated switch that commonly uses a coil to operate its internal switching mechanism. The relay includes a normally open (NO) terminal, a normally closed (NC) terminal, and a common terminal. In some examples, each DC-link capacitor 124 may be electrically connected to the normally open (NO) terminal of each relay S_{DC+}, S_{DC-} which is in turn electrically connected to the HV battery 140. In this case, when the relay S_{DC+}, S_{DC-} is not powered, then the circuit to the HV battery 140 is open, while when the relay S_{DC+}, S_{DC-} is powered, then the circuit to the HV battery 140 is closed and power flows to the HV battery 140. In other examples, each DC-link capacitor 124 may be electrically connected to the normally closed (NO) terminal of each relay S_{DC+}, S_{DC-} which is in turn electrically connected to the HV battery 140. In this case, when the relay S_{DC+}, S_{DC-} is powered, then the circuit to the HV battery 140 is open, while when the relay S_{DC+}, S_{DC-} is not powered, then the circuit to the HV battery 140 is closed and power flows to the HV battery 140. In some examples, switches may be used instead of the relays S_{DC+}, S_{DC-}.

Additionally, the system 100 includes a third Relay S_{P1A} and a fourth relay S_{P1B}. The third Relay S_{P1A} is electrically connected between the TAB primary H bridge 132a and the transformer 134 in the first TAB 130, 130a, i.e., the first APM 138a. The fourth relay S_{P1B} is electrically connected between the TAB primary H bridge 132a and transformer 134 in the second TAB 130, 130b, i.e., the second APM 138b. The third relay S_{P1A} and the fourth relay S_{P1B} are closed during the AC charging mode M1 to allow power flow from the DC-link capacitor 124 to the HV battery 140 and the LV load 150; and remain open during the traction and DC boost charging mode. The controller 102 controls the relays based on the inputs 12 causing the system 100 to adjust its behavior and function and execute one of the modes of operation M1, M2, M3.

In some examples, the system 100 connects to a Power Distribution Unit (PDU) box 160 supported by the vehicle 10. The PDU has relays and busbars that connect to the vehicle charging connectors. The PDU 160 distributes the power from the charging station 200 to the vehicle components based on the charging mode of the system. The PDU 160 includes AC circuitry 162 when connected to an AC connector and optionally DC circuitry 164 when connected to a DC connector. Additionally, the PDU box 160 includes a fifth relay S_{MA}, a sixth relay S_{MB}, and a seventh relay S_{MC}. When these relays are in the Open position, each relay bridges the connection between AC input 162 and the motor 110. When they are in the Closed position, these relays connect one end of the OEWM 110 three phase windings to a single point.

In some examples, an input electromagnetic interference (EMI) filter (not shown) may be electrically connected between the 240V_{AC} split phase/120V_{AC} single phase AC grid input 12 and the OEWM 110. The EMI filter protects the electronics within the system 100 from damage caused by high levels of radiation emitted by other electronic equipment. Additionally or alternatively, in some examples, an output EMI filter 170 may be electrically connected between the LV load 150, i.e., third port of the TAB 132c and the HV battery 140 i.e., second port of the TAB 132b.

### Modes of Operation

The system 100 is configured to operate under three mutually exclusive modes of operations shown in FIG. 3B: a first mode of operation being the traction mode M1, a second mode of operation being the AC charging mode M2, and an optional third mode of operation being the DC charging mode M3. The modes of operation M1, M2, M3 of the system 100 are associated with four functionalities: (i) traction drive, (ii) three/single phase AC charging, (iii) auxiliary power module (APM) for converting the high voltage from the HV battery 140 down to the LV load 150, and (iv) DC boost charging.

### First Mode of Operation: Traction Mode

FIG. 3B illustrates the system 100 A-M1 operating in the first mode of operation. When the controller 102 detects that the input data from the input 12 is indicative of the vehicle 10 moving, i.e., driving condition, for example, from one or more sensors 14 supported by the vehicle 10, then the controller 102 executes the first mode of operation M1. The first mode of operation M1 is only available and can only be executed when the vehicle 10 is in a driving condition. During the first mode of operation M1, the system 100A-M1 utilizes the HV battery 140 to charge and/or supply power to the LV load 150 and to supply power to the OEWM 110. The traction inverter 120 and the DC-link capacitor 124, together operate as 2-level voltage source inverter which modulates the DC power from the HV battery 140 to AC power to drive the OEWM 110. The OEWM stator windings 112 are tied together at one end to form a conventional Y-connected 3P machine. In addition, during the first mode of operation M1 the HV battery 140 simultaneously charges the LV loads 150, 150a, 150b through the APMs 138, 138a, 138b.

Furthermore, during the traction mode M1, the first and second relays S_{DC+}, S_{DC-} of the system 100A-M1 are closed to connect the HV battery 140 to the DC links capacitor 124 of the traction inverter 120. Each active bridge 132 of the TAB 130 galvanically connects the DC-link capacitor 124 (Port 1), HV battery 140 (Port 2), and LV load 150 (e.g., LV battery or load) (Port 3). The third relays S_{P1A} and the fourth relay S_{P1B} from the top and bottom banks are disconnected i.e., open during the traction mode M1 to prevent circulating current in the Port 1 H-Bridge which could damage the switches in port 1 132a, and the DC-link capacitors 124. The HV Battery 140 (Port 2) and the LV load 150 (Port 3) are galvanically connected through a dual active bridge (DAB) circuit 132b, 132c. This allows the power to flow from the HV battery 140 to charge the LV load 150 during the first mode of operation M1.

### Second Mode of Operation: AC Charging Mode

The system 100A-M2 operates in the second mode of operation. When the controller 102 detects that the input data from the input 12 is indicative of the vehicle 10 being charged by an alternating voltage source 200, such as 400V_{AC} three phase/120V_{AC} single phase grid, then the controller 102 executes the second mode of operation M2. The second mode of operation M2 is only available and can only be executed when the vehicle 10 is parked and being charged by a 400V_{AC} three phase/120V_{AC} single phase grid, i.e., the input 12 is 400V_{AC} three phase or 120V_{AC} single phase. During the second mode of operation M2 the OEWM 110 and the switches 122 of the inverter 120 operate as three phase PFC 180 for 3P/1P AC charging. The OEWM winding inductance 112 is utilized as the PFC boost coil. The PFC circuit 180 converts the AC grid voltage into DC voltage to charge the HV battery 140 and the LV load 150. In addition, the PFC circuit 180 also regulates the input power factor and current THD (Total Harmonic Distortion) to comply with the given standards.

As such, the inverter 120 can be reconfigured as a three phase PFC 180 for 3P/1P AC charging. The three port DC-DC converter 130 enables high voltage and low voltage charging simultaneously. The DC-DC converter 130 transfers the DC bus power to charge the HV battery 140 via the HV DC-DC converters 136, 136a, 136b and LV load 150 (e.g., step down voltage) via the LV DC-DC converters 138, 138a, 138b simultaneously, and the three-port transformer 134 provides galvanic isolation between the AC input 12, HV battery 140, and LV loads 150, 150a, 150b. The dual bank configuration provides redundancy, which is required by some EV manufacturers.

This system 100A eliminates the need for PFC coils, and PFC switches, utilizing the OEWM winding inductance 112 and traction inverter power module switches 122 to achieve significant power device reduction; bi-directional power flow; and Dual bank configuration to fully utilize maximum charging power. Furthermore, the TAB converter 130 also enables reverse power operation for vehicle-to-everything (V2X). As shown, relays S_{MA}, S_{MB}, S_{MC}, S_{DC+}, and S_{DC-} are open, and relays S_{P1A}, S_{P1B} are closed.

### Third Mode of Operation: DC Charging In Boost Mode

The system 100A-M3 operates in the third mode of operation M3. When the controller 102 detects that the input data of the input 12 is indicative of the vehicle 10 being charged by a DC voltage source, such as a 400 V DC charging station 200, then the controller 102 executes the third mode of operation M3. The third mode of operation M3 is only available and can only be executed when the vehicle 10 is parked and being charged by a DC charging station 200, i.e., the input 12 is 400 V DC. The DC boost charging functionality allows the 800 V battery 140 to be charged with a legacy 400 V DC fast charger. The electric vehicle supply equipment (EVSE) 200, i.e., the input 12, is boosted up to the HV battery voltage. In other words, the 400 V DC input 12 is boosted up to 800 V to charge the 800 V HV battery 140. In this mode, relays, S_{MA}, S_{MB}, S_{MC}, S_{P1A}, and S_{P1B} are open, whereas S_{DC+}, S_{DC-} are closed.

During the third mode of operation M3, the OEWM 110 and the inverter 120 operate as a three-phase boost converter 190. Since a basic boost converter converts a DC voltage to a higher voltage, the behavior of the circuit as a three-phase boost converter 190 reduces the inductor ripple current which in this case is the motor winding and output voltage ripple of the DC-link capacitor 124. Additionally, utilizing traction inverter switches 122 achieves significant power device reduction. This configuration can be added to any existing e-drive platform design with the minimum modification. In addition, the dual bank 124 configuration achieves high power charging.

This mode of operation also utilizes all three windings of the OEWM 110 to form a three-phase interleaved converter 190, which operates in continuous conduction mode (CCM) mode. The Port 1 H-bridge that connects to the DC-link capacitor 124 of the TAB 130 is disconnected in the third mode of operation M3 by opening relays S_{P1A} and S_{P1B}, and HV battery 140 (Ports 2) and the LV load 150 (Port 3) are galvanically connected through a Dual Active Bridge (DAB) 134 circuit. This allows the LV loads 150 to be charged during the DC boost charging mode M3 by the HV battery 140. As shown, only 4 switches 122 are being used due to the DC-DC topology.

### Exemplary Topologies

The following exemplary topologies are based on the system 100A described above. Each system 100B-100I may function in at least two of the three modes of operations: the first mode of operation or the traction mode M1, the second mode of operation or the AC charging mode M2, and optionally the third mode of operation or the DC charging boost Mode M3. Based on one or more inputs 12, the controller 102 determines which mode of operation M1, M2, M3 the system 100B-100I will operate in. For example, the traction mode of operation M1 is executed when the controller 102 receives input data at the input 12 from one or more sensors supported by the vehicle 10 and determines that the input data is indicative of the vehicle 10 being driven or moving. During the traction mode M1, the HV battery 140 supplies power to the OEWM 110 and optionally the HV battery charges and/or supplies power to the LV load(s) 150 when the system 100 includes at least one APM 138.

The AC charging mode M2 of operation is executed when the controller 102 detects that the input data from the input 12 is indicative of the vehicle 10 being parked and connected to an alternating voltage source 200, such as 400V_{AC} three phase/120V_{AC} single phase grid, then the controller 102. During the AC charging mode M2 the voltage from the AC grid 200 is converter into DC voltage to charge the HV battery 140 and optionally the LV load(s) 150, when one or more APMs 138 are available. The DC boost charging mode M3 of operation is executed when the controller 102 detects that the input data of the input 12 is indicative of the vehicle 10 being parked and being charged by a DC voltage source 200, such as a 400 V_{DC} charging station 200, then the controller 102. During the DC boost charging mode M3, the voltage of the legacy 400 V _{DC} fast charger 200 is boosted up to charge the HV battery 140 and optionally the LV load(s) 150 when one or more APMs 138 are available.

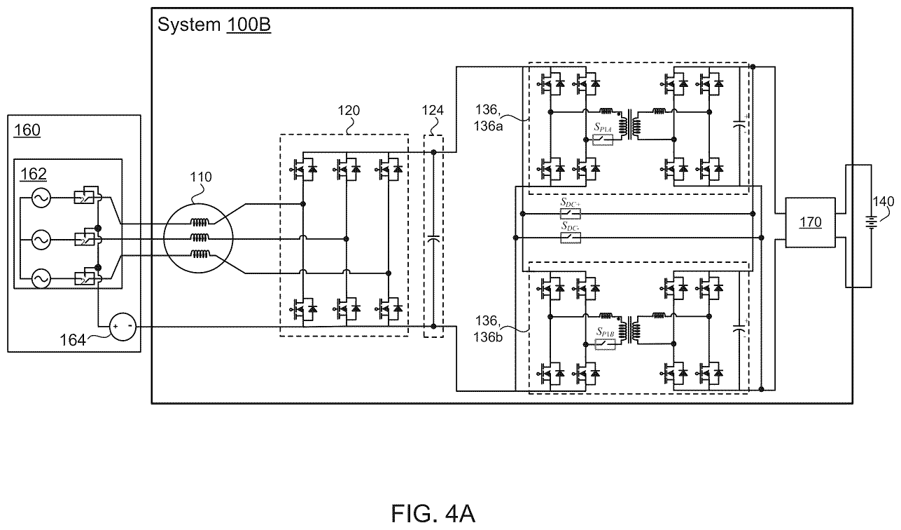

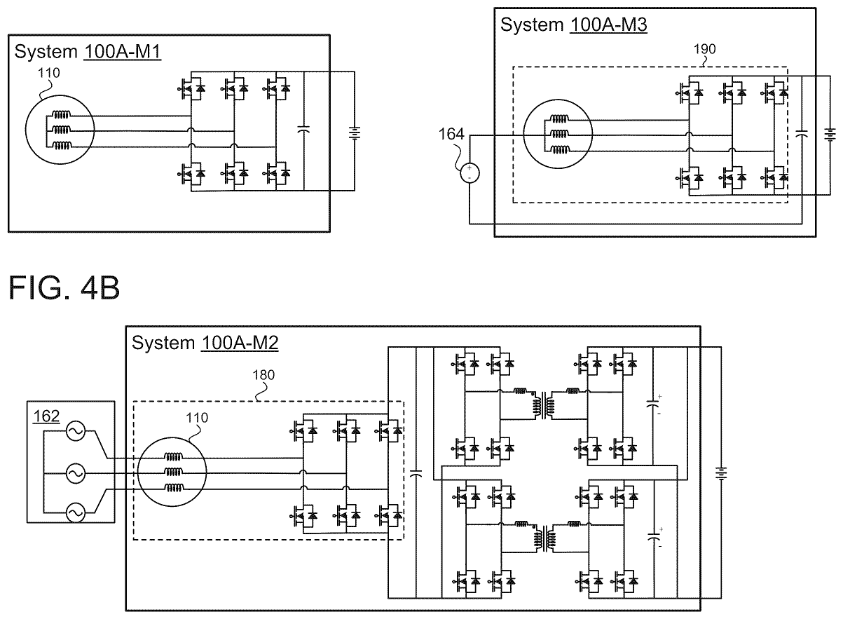

FIGS. 4A and 4B: FIG. 4A shows a system 100B based on the system 100A shown in FIG. 3A; however, the system 100B does not include the APM units 138 which connect to the LV loads 150. FIG. 4B shows the modes of operation that this system 100B can operate in. For example, during the traction mode M1, the HV battery 140 of the system 100B-M1 supplies power to the OEWM 110. During the AC charging mode M2, the voltage from the AC grid 200 is converter into DC voltage to charge the HV battery 140 of the system 100B-M2. Additionally, during the DC boost charging mode M3, the voltage of the legacy 400 V DC fast charger 200 is boosted up to charge the HV battery 140 of the system 100B-M3.

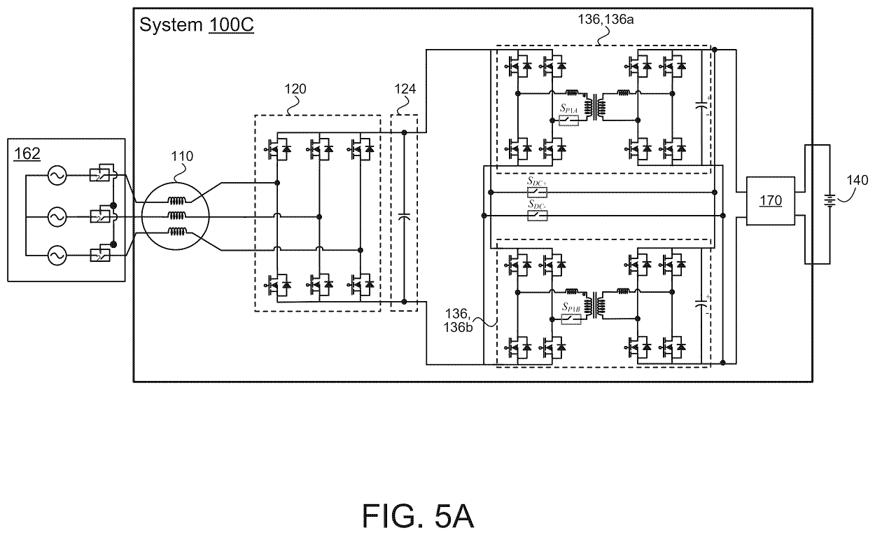

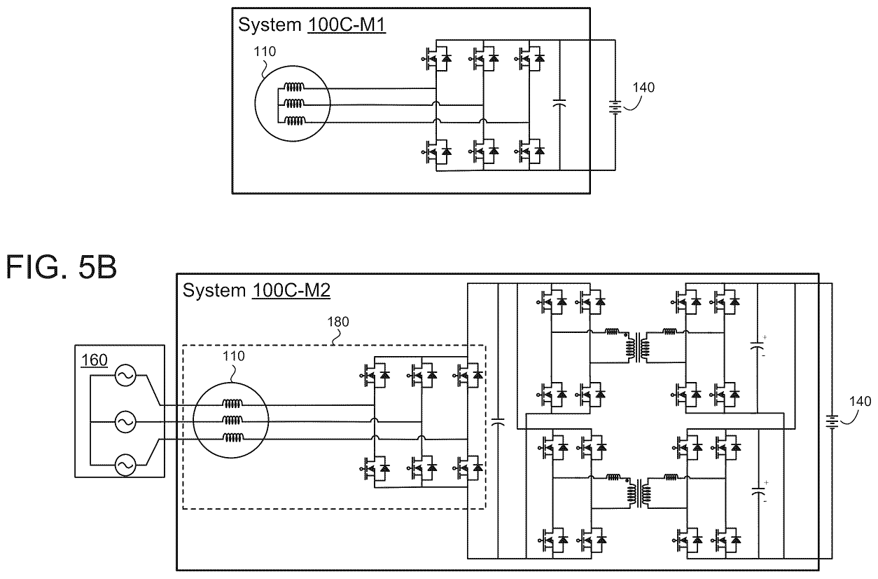

FIGS. 5A and 5B: FIG. 5A shows a system 100C based on the system 100B shown in FIG. 4A; however, the system 100C does not support the DC charging mode M3 since the PDU 160 does not include DC charging circuitry 164 to receive DC input 12. FIG. 5B shows the modes of operation that this system 100C can operate in. Similar to the system 100B-M1, during the traction mode M1, the HV battery 140 of the system 100C-M1 supplies power to the OEWM 110. Similar to the system 100B-M2, during the AC charging mode M2, the voltage from the AC grid 200 is converter into DC voltage to charge the HV battery 140 of the system 100C-M2.

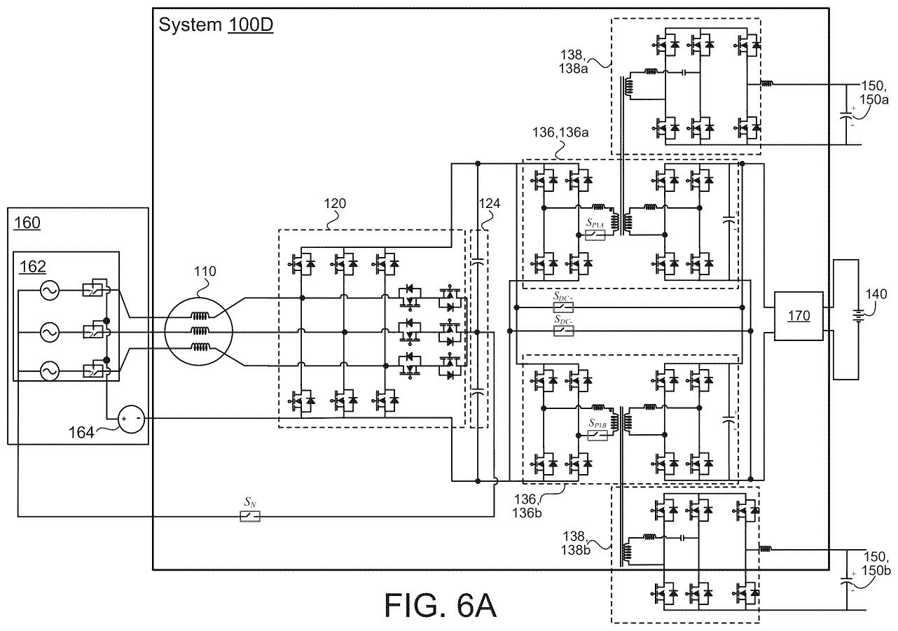

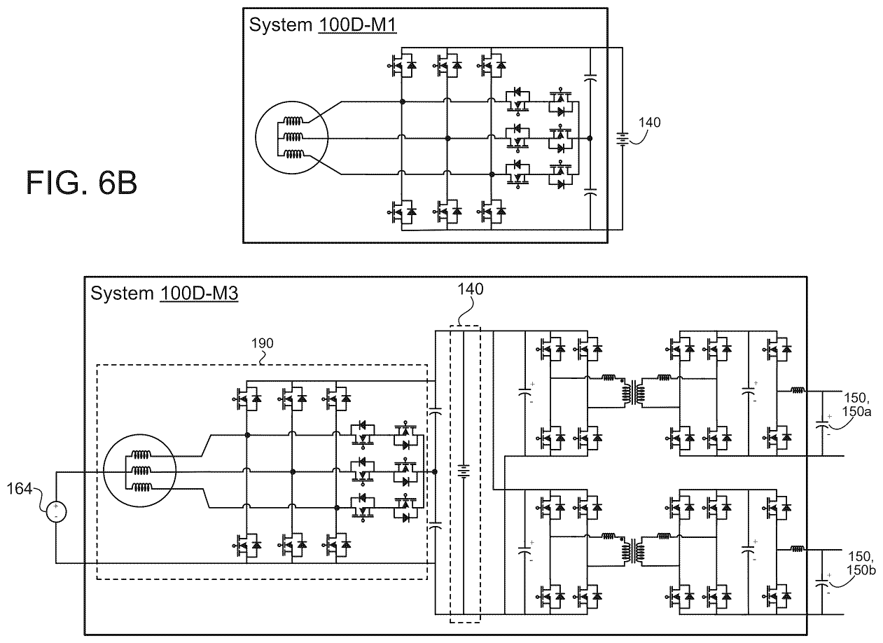

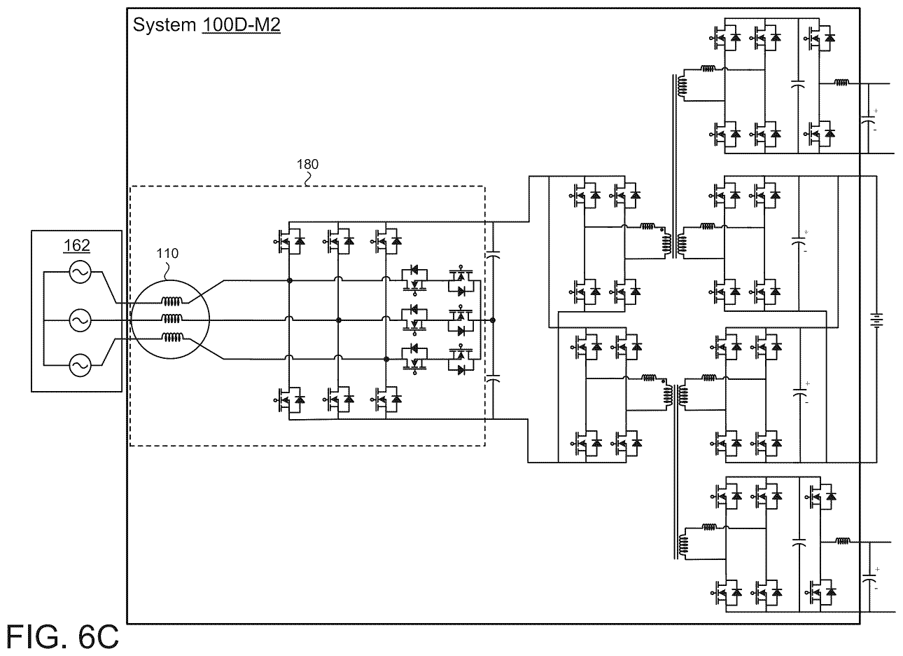

FIGS. 6A and 6B: FIG. 6A shows a system 100D based on the system 100A shown in FIG. 3A; however, the traction inverter 120 is a 3L T-type traction inverter having a different architecture than the traction inverter of system 100A as can be seen in the figure. The 3L T-type inverter 120 improves the system efficiency and output current THD compared to a conventional 2 L voltage source inverter (VSI).

FIG. 6B shows the modes of operation that this system 100D can operate in. For example, during the traction mode M1, the HV battery 140 of the system 100B-M1 supplies power to the OEWM 110. The 3 L T-type traction inverter operates with three voltage levels which modulates the DC power from the HV battery 140 to AC power to drive the OEWM 110. This means that instead of the conventional 2 L VSI with two level switching (High and Low), the inverter 120 can also generate a third voltage level at 0V. A T-type 3L inverter is a specific 3L inverter topology. T-type 3L inverters typically feature three switching legs, resembling the letter “T” when viewed schematically. The OEWM stator windings 112 are tied together at one end to form a conventional Y-connected 3P machine. The 3L T-type inverter 120 improves the system efficiency and output THD compared to a conventional 2L voltage source inverter (VSI). Additionally, the traction drive system is used for 800 V battery voltage.

During the AC charging mode M2, the voltage from the AC grid 200 is converter into DC voltage to charge the HV battery 140 of the system 100B-M2. In this mode M2, the OEWM 110 and the 3L T-type traction inverter 120 operate as a Vienna PFC 180 for 3P/1P charging. The Vienna PFC 180 operates in continuous conduction mode (CCM), inherent multilevel switching (three-level), and provides reduced power voltage stress on the power devices. Similar to the previously described systems, the three port DC-DC converter enables HV and LV charging simultaneously. Additionally, the system 100D allows for Bi-directional power flow.

Additionally, during the DC boost charging mode M3, the voltage of the legacy 400 V DC fast charger 200 is boosted up to charge the HV battery 140 of the system 100B-M3. The OEWM 110 and the 3L T-type traction inverter 120 operate as a 3P interleaved boost converter 190. The three phase windings of the OEWM are used as the boost inductors, and all three phase legs of the inverter are switching at high frequency.

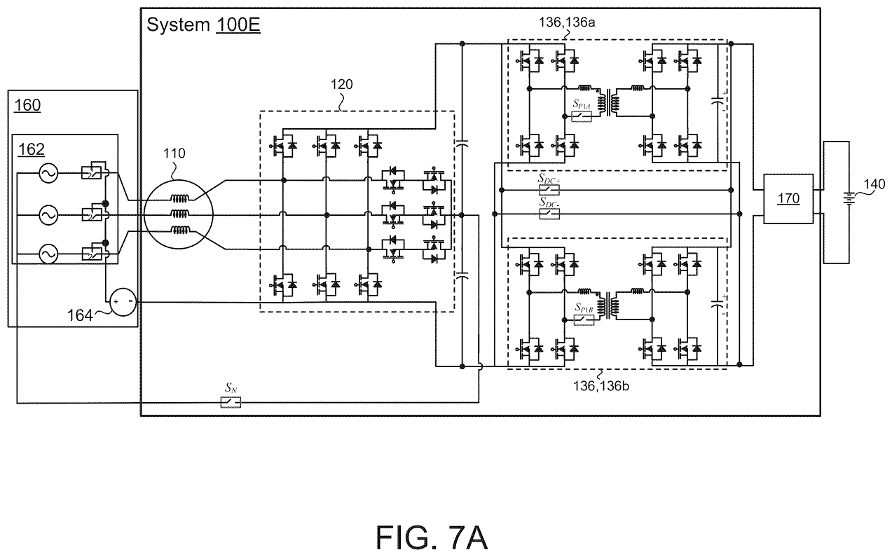

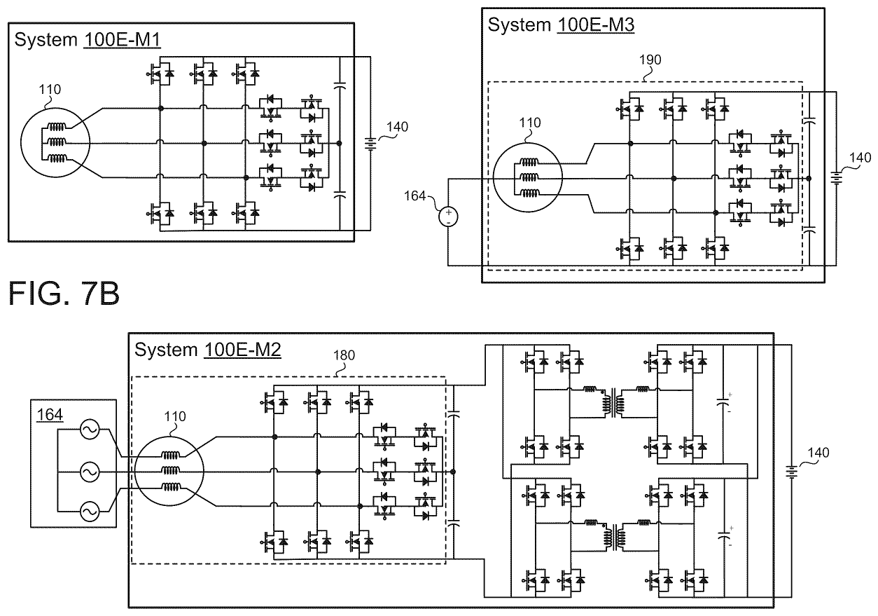

FIGS. 7A and 7B: FIG. 7A shows a system 100E based on the system shown 100D in FIG. 6A without the APMs 138. FIG. 7B shows the modes of operation that this example can operate in: Traction Mode M1, AC Charging Mode M2, and DC Boost charging mode M3. For example, during the traction mode M1, the HV battery 140 of the system 100D-M1 supplies power to the OEWM 110. During the AC charging mode M2, the voltage from the AC grid 200 is converter into DC voltage to charge the HV battery 140 of the system 100D-M2. Additionally, during the DC boost charging mode M3, the voltage of the legacy 400 V DC fast charger 200 is boosted up to charge the HV battery 140 of the system 100B-M3.

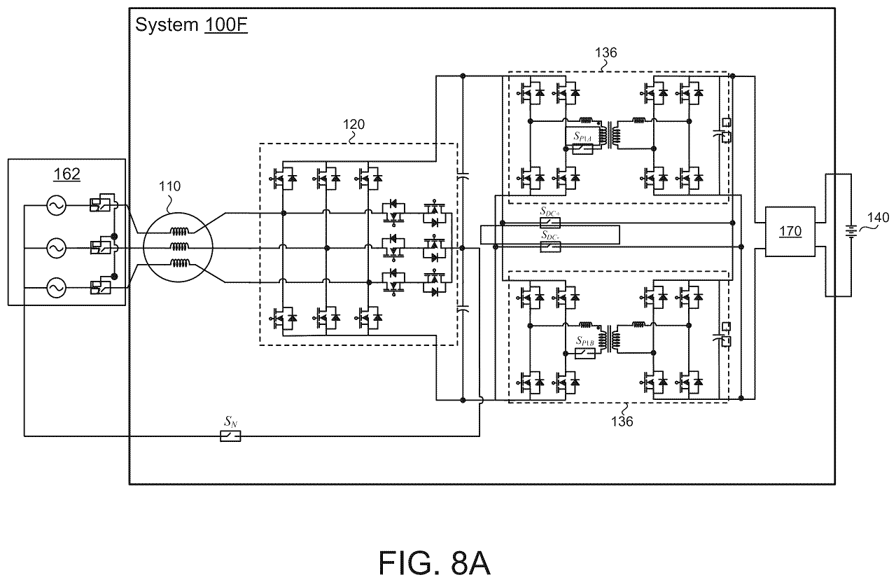

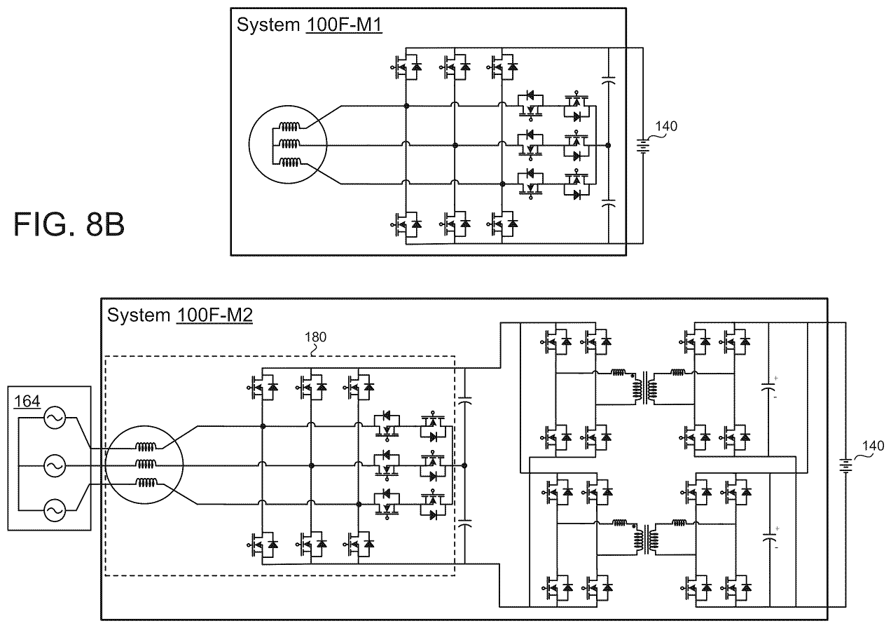

FIGS. 8A and 8B: FIG. 8A shows a system 100F based on the system shown in FIG. 7A without the DC charging circuitry 164. Therefore, this system 100E does not support the DC boost charging mode M3. FIG. 8B shows the modes of operation that this system 100E can operate in. Similar to the system 100D-M1, during the traction mode M1, the HV battery 140 of the system 100E-M1 supplies power to the OEWM 110. Similar to the system 100D-M2, during the AC charging mode M2, the voltage from the AC grid 200 is converter into DC voltage to charge the HV battery 140 of the system 100E-M2.

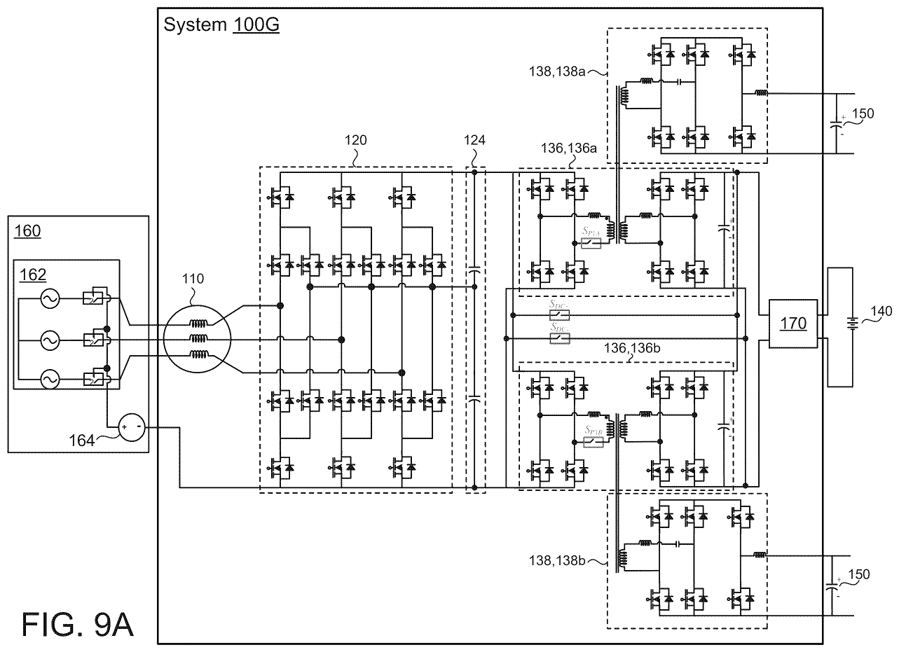

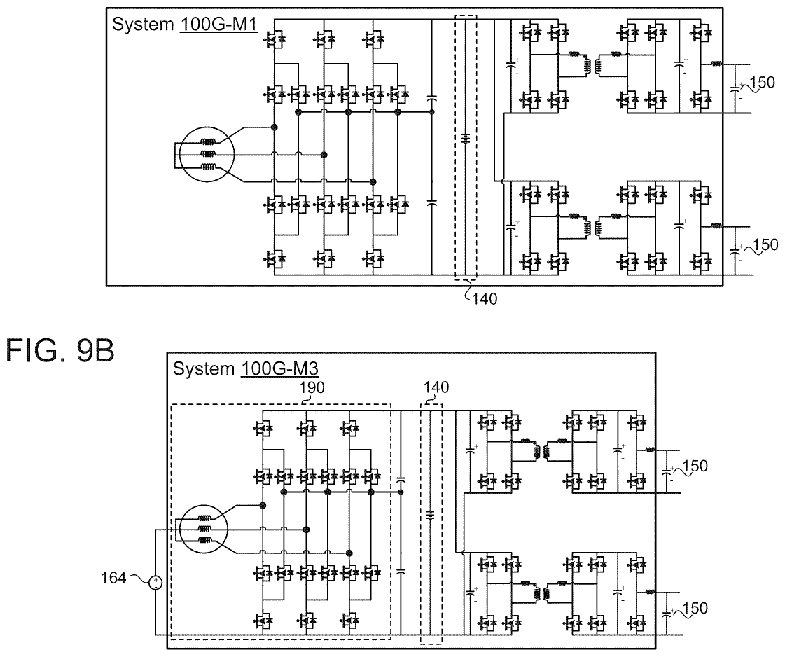

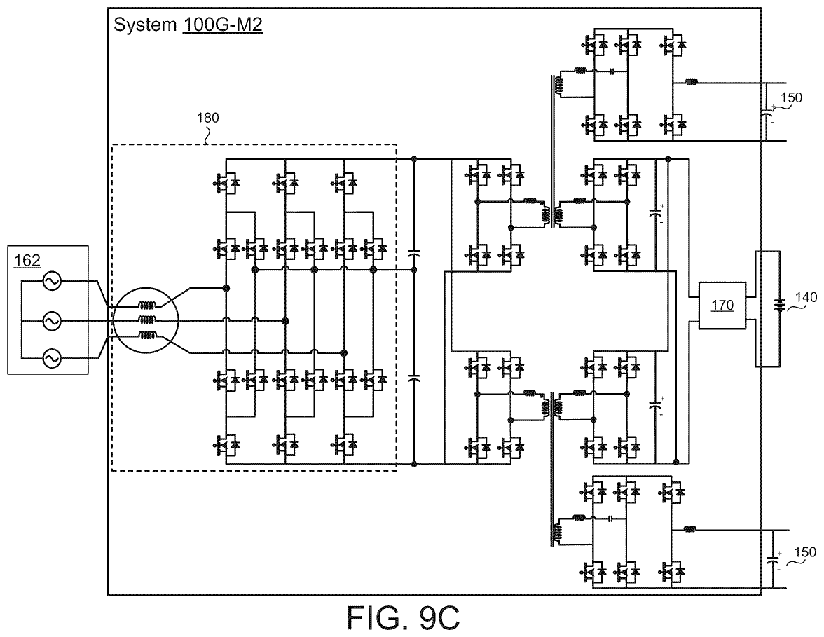

FIGS. 9A, 9B and 9C: FIG. 9A shows a system 100G based on the system shown in FIG. 5A; however, the traction inverter 120 is a GaN (Gallium Nitrade) based 3L ANPC (active neutral-point-clamped) traction inverter. The 3L ANPC is a special type of 3L inverter, each phase leg of the inverter has 6 switches, and two of those switches are connected to the neutral of the DC link 124. Compared to the 3L T type inverter, all the switches in 3L ANPC have half of the DC link voltage across them when turned-on. This makes it possible to use all GaN switches in 3L ANPC for 800V battery EVs, to further increase the inverter efficiency. FIGS. 9B and 9C show the modes of operation that this system 100G can operate in. For example, during the traction mode M1 shown in FIG. 9B, the HV battery 140 of the system 100G-M1 supplies power to the OEWM 110. The ANPC inverter 120 modulates the DC voltage into 3L three-phase AC voltage to drive the OEWM 110. The ANPC allows the use of 650 V GaN switch, which is not possible for a conventional 2-level VSI with 800 V battery. The utilization of GaN switches improves the efficiency for all modes of operation. During the AC charging mode M1, the OEWM 110 and the inverter 120 behave as a 3 phase ANPC PFC 180. The motor windings are used as the PFC boost inductor, and the 3 phase ANPC PFC converters the input AC voltage into DC voltage to charge the HV battery 140.

Additionally, during the DC boost charging mode M3, the voltage of the legacy 400 V DC fast charger 200 is boosted up to charge the HV battery 140 of the system 100B-M3. In this mode, the OEWM 110 and the inverter 120 behave as a 3 phase interleaved boost converter 190. The motor windings are used as the boost inductors, and 4 out of the 6 switches in each ANPC phase legs are switching at high frequency. This system 100G provides efficiency improvements compared to 2 L Voltage Source Inverter (VSI), improved output voltage total harmonic distortion (THD) resulting in an improved motor efficiency, and APM is active during the traction mode of operation. The AC charging mode M2 shown in FIG. 9C provides a three phase ANPC PFC 190 that supports both 3P/1P AC charging, eliminates the need for PFC coils by using the motor inductance, utilizes traction inverter power module switches to achieve significant power device reduction, provides bi-directional power flow, and provides triple active bridge DC-DC with three port transformer to achieve a high level of integration, and cost saving. The DC Boost charging mode M3 shown in FIG. 9B eliminates the need for DC boost inductors by using the machine winding inductance, utilizing traction inverter power module switches to achieve significant power device reduction, and provides that the APM is active during DC boost charging mode.

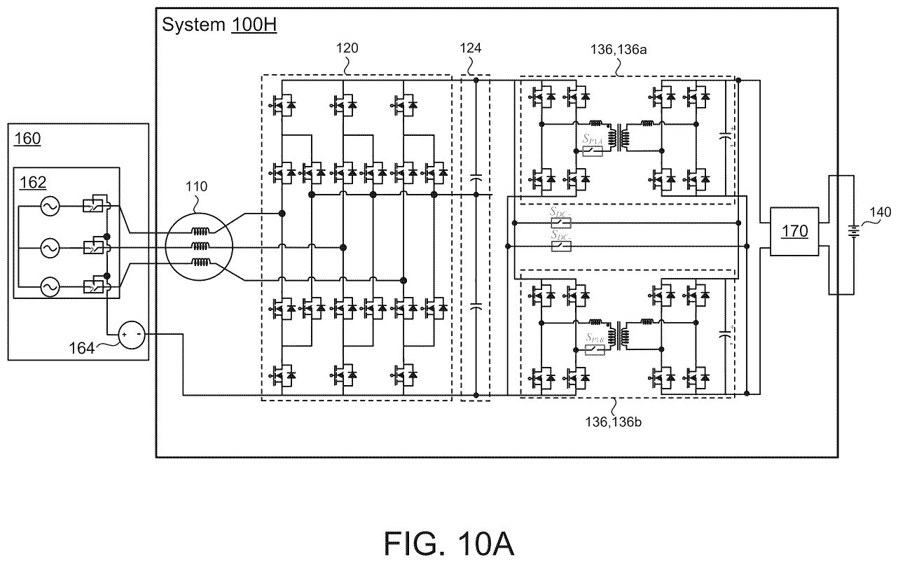

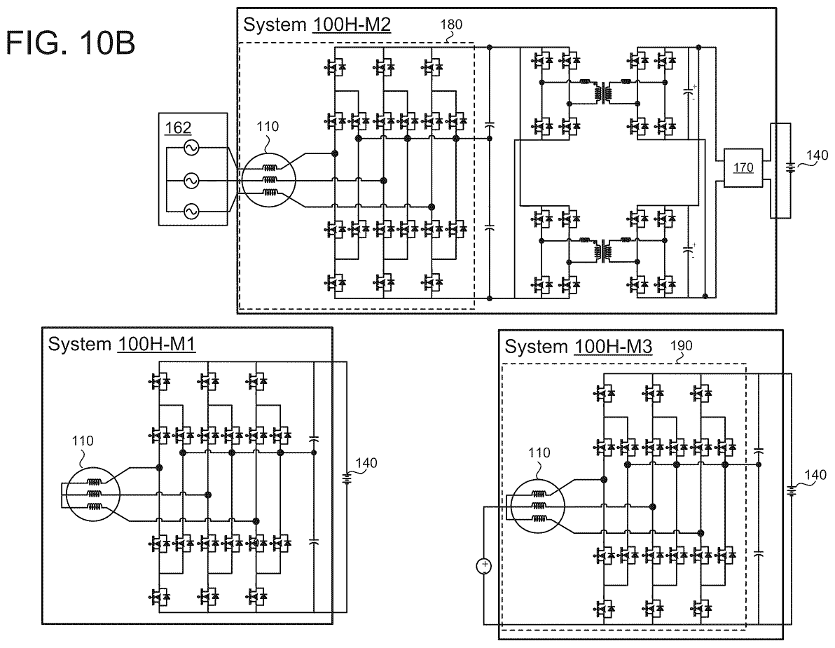

FIGS. 10A and 10B: FIG. 10A shows a system 100H based on the system shown in FIG. 9A without the APM modules 138. FIG. 10B shows the modes of operation that this example can operate in: Traction Mode M1, AC Charging Mode M2, and DC Boost charging mode. For example, during the traction mode M1, the HV battery 140 of the system 100H-M1 supplies power to the OEWM 110. During the AC charging mode M2, the voltage from the AC grid 200 is converter into DC voltage to charge the HV battery 140 of the system 100H-M2. Additionally, during the DC boost charging mode M3, the voltage of the legacy 400 V DC fast charger 200 is boosted up to charge the HV battery 140 of the system 100B-M3.

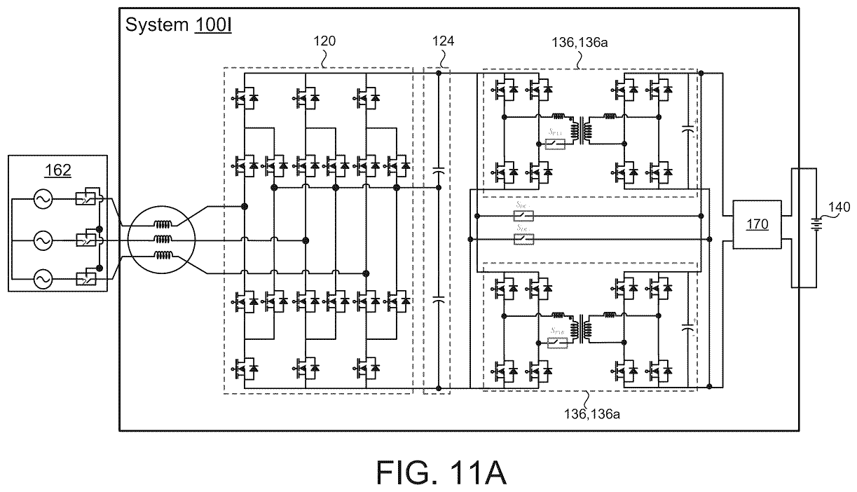

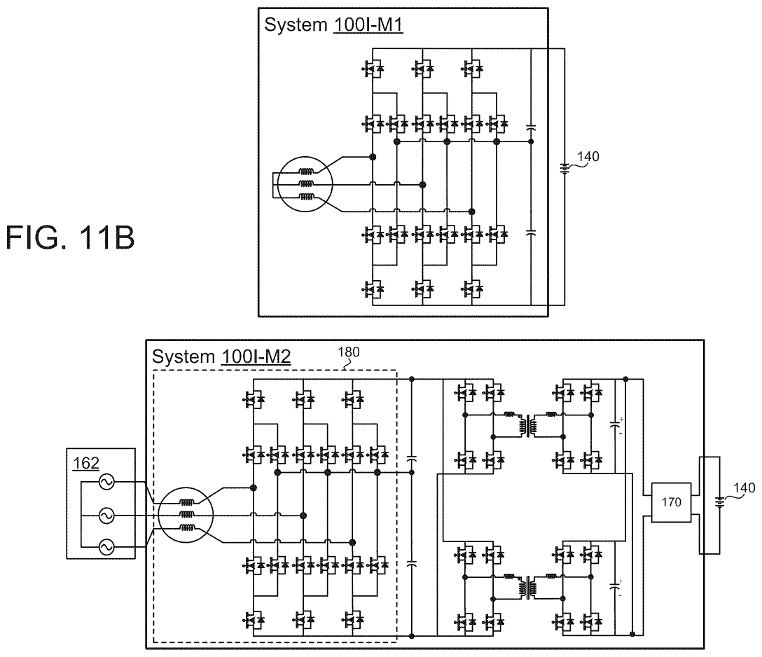

FIGS. 11A and 11B: FIG. 11A shows a system 100I based on the system shown in FIG. 10A without the DC boost charging. FIG. 11B shows the modes of operation that this system 100E can operate in. Similar to the system 100H-M1, during the traction mode M1, the HV battery 140 of the system 100E-M1 supplies power to the OEWM 110. Similar to the system 100D-M2, during the AC charging mode M2, the voltage from the AC grid 200 is converter into DC voltage to charge the HV battery 140 of the system 100E-M2.

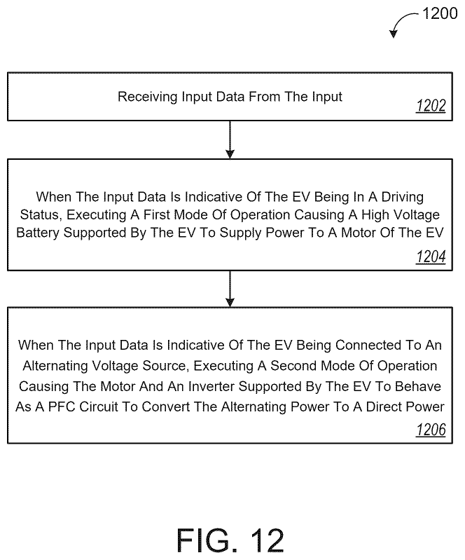

FIG. 12 provides an example arrangement of operations for a method 1200 for operating the system 100, 100A-100I described in FIGS. 3A-11B based on an input 12 received by the system 100, 100A-100I. At block 1202, the method 1200 includes receiving input data from the input 12. In some examples, the input data includes at least one of a voltage sensor data, a current sensor data, and vehicle motion sensor data. When the input data is indicative of the EV 10 being in a driving status, the method 1200 at block 1204 includes executing a first mode of operation M1 (Traction mode) causing an HV battery 140 supported by the EV 10 to supply power to an OEWM 110 of the EV 10. In some examples, where the system 100 includes one or more low voltage loads 150, 150a, 150b, then the HV battery 140 also supplies power to the LV load 150. When the input data 12 is indicative of the EV 10 being connected to an alternating voltage source 200, the method 1200 at block 1206 includes executing a second mode of operation M2 (AC charging mode) causing the OEWM 110 and an inverter 120 supported by the EV 10 to behave as a PFC circuit 180 (e.g., a three phase PFC, a 3 phase Vienna PFC, or a 3 phase ANPC PFC) to convert alternating power from the voltage source 200 to direct power. In this mode of operation M2, the direct power is used to charge the HV battery 140 and when available, the one or more LV loads 150. In some examples, where the topology of the system 100 supports DC boost charging (i.e., when a PDU 160 of the vehicle 10 includes DC charging circuitry 164), then when the input data 12 is indicative of the EV 10 being connected to a direct voltage source 200, such as a 400V DC, the method 1200 includes executing a third mode of operation M3 (DC boost charging mode) causing the OEWM 110 and the inverter 120 to behave as a boost converter circuit 190 to boost the direct power from the direct voltage source 200. In this mode of operation M3, the boosted direct power is used to charge the HV battery 140 and when available the one or more LV loads 150. The first, second, and third modes of operation (M1, M2, M3) are mutually exclusive.

The system 100 and method 1200 described provide highly integrated power electronics system for EVs. Different power electronics conversions inside the EV are integrated into one system 100 in one box to save costs and achieve volume reduction. Firstly, the most market adopted three phase Y-connected motor without the neutral terminal is used in the system 100, without any modification or specialization, such as Open Ended Winding Machine or Six-Phase Machine. The three-phase motor windings 112 are used in the system 100 for realizing the PFC coil for front end PFC converter of OBC and inductors for an interleaved boost converter for DC boost charging. Secondly, an integrated isolation transformer for DC-DC conversion is described with three ports, such that two secondary output ports were shown in the design for HV DC-DC conversion and for LV DC-DC conversion. Thirdly, dual bank architecture offers system redundancy.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

1. A system operating in at least two modes of operation based on an input, the system supported by an electric vehicle, the system comprising:
an input receiving input data from one or more sensors;
an Open-Ended Winding Machine (OEWM);
an inverter connected to the OEWM;
a DC-link capacitor connected to the inverter; and
a DC-DC converter connected to the DC-link capacitor and a high voltage (HV) battery.

2. The system of claim 1, wherein the DC-DC converter comprises a HV DC-DC converter providing bidirectional power to and from the HV battery.

3. The system of claim 2, wherein the DC-DC converter comprises a LV DC-DC converter configured to supply power to a LV load.

4. The system of claim 1, wherein the DC-DC converter includes a first DC-DC converter and a second DC-DC converter.

5. The system of claim 1, wherein when the input data is indicative of the EV being in a driving status, the HV battery supplies power to the OEWM during a traction mode of operation.

6. The system of claim 1, wherein when the input data is indicative of the EV connected to an alternating voltage source, the OEWM and the inverter behave as a three phase Vienna PFC to convert alternating power from the alternating voltage source to direct power during an AC charging mode of operation.

7. The system of claim 1, wherein when the input data is indicative of the EV connected to an alternating voltage source, the OEWM and the inverter behave as a three phase 3 phase ANPC PFC to convert alternating power from the alternating voltage source to direct power during an AC charging mode of operation.

8. The system of claim 1, wherein when the input data is indicative of the EV connected to a direct voltage source, the OEWM and the inverter behave as a three-phased interleaved boost converter circuit to boost direct power from the direct voltage source during a DC boost charging mode of operation.

9. The system of claim 1, wherein the OEWM is a 3-Phase motor with neutral access point.

10. The system of claim 1, wherein the inverter includes one of two-level voltage source inverter, a three-level voltage source inverter, or a Gallium Nitrade 3L active neutral-point-clamped (ANCP) traction inverter.

11. The system of claim 1, wherein the DC-link capacitor is a split DC-link capacitor.

12. The system of claim 1, wherein the one or more sensors include voltage sensor, current sensors, and vehicle motion sensor.

13. A method of operating a system based on an input to the system the system supported by an electric vehicle (EV), the method comprising:
receiving input data from the input;
when the input data is indicative of the EV being in a driving status, executing a first mode of operation causing a high voltage battery supported by the EV to supply power to an Open-Ended Winding Machine (OEWM) of the EV; and
when the input data is indicative of the EV being connected to an alternating voltage source, executing a second mode of operation causing the OEWM and an inverter supported by the EV to behave as a PFC circuit to convert alternating power from the alternating voltage source to direct power.

14. The method of claim 13, further comprising when the input data is indicative of the EV being connected to a direct voltage source, executing a third mode of operation causing the OEWM and the inverter to behave as a three-phase interleaved boost converter circuit to boost direct power from the direct voltage source.

15. The method of claim 13, wherein the first, second, and third modes of operation are mutually exclusive.

16. The method of claim 13, wherein the first mode of operation causes the high voltage battery to supply power to one or more low voltage loads supported by the EV.

17. The method of claim 13, wherein the input data includes at least one of a voltage sensor data, a current sensor data, and vehicle motion sensor data.

18. The method of claim 13, wherein the PFC circuit includes a three-phase Vienna PFC or a 3 phase ANPC PFC.
